(19) United States
(12) Patent Application Publication
(10) Pub. No.: US 2026/0030631 A1
(43) Pub. Date: Jan. 29, 2026

(54) ELECTRONIC LOCKER CONTROL METHOD, SYSTEM, AND APPARATUS, STORAGE MEDIUM, ELECTRONIC DEVICE, AND PROGRAM PRODUCT

(71) Applicant: Tencent Technology (Shenzhen) Company Limited, Shenzhen (CN)

(72) Inventors: Shaoming WANG, Shenzhen (CN); Runzeng GUO, Shenzhen (CN); Jinkun HOU, Shenzhen (CN); Nanjin CHEN, Shenzhen (CN)

(21) Appl. No.: 19/334,653

(22) Filed: Sep. 19, 2025

Related U.S. Application Data
(63) Continuation of application No. PCT/CN2024/103046, filed on Jul. 2, 2024.

(30) Foreign Application Priority Data
Sep. 14, 2023 (CN) 202311191242.9

(51) Int. Cl. G06Q 20/40; G07C 9/00; G07C 9/37; G07C 9/38; G07F 17/12

(52) U.S. Cl. CPC G06Q 20/40145; G07C 9/00563; G07C 9/00571; G07C 9/00896; G07C 9/37; G07C 9/38; G07F 17/12

(57) ABSTRACT

Embodiments of this application disclose an electronic locker control method performed by an electronic device. The method includes: invoking a biometric feature collection device to collect the second biometric feature of the first target object in response to a pickup operation of the first target object for the electronic locker, and matching the second biometric feature of the first target object with first biometric features in the biometric feature database; transmitting a pickup payment request to the first server when the first biometric feature matching the second biometric feature exists in the biometric feature database; and transmitting the first opening instruction to a target electronic storage compartment corresponding to the first target order in the electronic locker to control a locker door of the target electronic storage compartment to be opened when receiving a payment success response returned by the first server.

### CROSS-REFERENCE TO RELATED APPLICATIONS

This application is a continuation application of PCT Patent Application No. PCT/CN2024/103046, entitled “ELECTRONIC LOCKER CONTROL METHOD, SYSTEM, AND APPARATUS, STORAGE MEDIUM, ELECTRONIC DEVICE, AND PROGRAM PRODUCT” filed on Jul. 2, 2024, which claims priority to Chinese Patent Application No. 202311191242.9, entitled “ELECTRONIC LOCKER, ELECTRONIC LOCKER CONTROL SYSTEM, AND ELECTRONIC LOCKER CONTROL METHOD AND APPARATUS” filed with the Chinese National Intellectual Property Administration on Sep. 14, 2023, both of which are incorporated by reference in their entirety.

### FIELD OF THE TECHNOLOGY

This application relates to the field of logistics and express technology, and in particular, to an electronic locker control method, system, and apparatus, a storage medium, an electronic device, and a program product.

### BACKGROUND OF THE DISCLOSURE

With the rapid development of the logistics field, a volume of express deliveries has been increasing year by year. To facilitate users in receiving and sending parcels, electronic lockers, such as self-service express pickup lockers, have been installed near residential communities, office buildings, and other areas. Delivery personnel place parcels into the electronic lockers, allowing the users to retrieve them.

Currently, when picking up the parcel from the electronic locker, a user can either input a pickup code or scan a code to log into an express application and perform a pickup operation (e.g., a login two-dimensional code), which triggers a locker door to be opened automatically, completing the pickup. However, if a storage duration of a parcel that the user intends to pick up exceeds a preset duration, the user is prompted that the parcel has been stored for too long after inputting the pickup code or scanning the code, and is required to pay a corresponding pickup fee. In this case, an additional payment process for the pickup fee needs to be carried out, and only after the payment is completed will the locker door open.

Evidently, a current pickup process is complex and redundant, resulting in low pickup efficiency. Therefore, how to achieve a simple pickup process and improve a user pickup efficiency has become an urgent problem that needs to be solved.

### SUMMARY

Embodiments of this application provide an electronic locker control method, system, and apparatus, a storage medium, an electronic device, and a program product, to solve the problem of a complex pickup process in the related art. To achieve the foregoing objective, the embodiments of this application provide the following technical solutions:

According to one aspect, an embodiment of this application provides an electronic locker control method, performed by a first electronic device, the electronic locker being configured with a biometric feature collection device and a plurality of electronic storage compartments, and the method including:
invoking the biometric feature collection device to collect the second biometric feature of the first target object in response to a pickup operation of the first target object for the electronic locker;
matching the second biometric feature of the first target object with first biometric features in the biometric feature database;
transmitting a pickup payment request to the first server when the first biometric feature matching the second biometric feature exists in the biometric feature database; and
opening a target electronic storage compartment in the electronic locker according to a first target order associated with the first target object after receiving a payment success response returned by the first server.

According to another aspect, an embodiment of this application provides a non-transitory computer-readable storage medium, having a computer program stored therein, the computer program, when executed by a processor, implementing the method provided in any exemplary embodiment of this application.

According to another aspect, an embodiment of this application provides the first electronic device, connected to an electronic locker, the electronic locker being configured with a biometric feature collection device and a plurality of electronic storage compartments, the first electronic device including a memory, a processor, and a computer program stored in the memory, and the processor, when executing the program, implementing the foregoing electronic locker control method, for invoking the biometric feature collection device and controlling opening of the electronic storage compartments.

According to another aspect, an embodiment of this application provides the second electronic device, including a memory, a processor, and a computer program stored in the memory, the processor, when executing the program, implementing the foregoing electronic locker control method.

According to another aspect, an embodiment of this application further provides a computer program product, including a computer program, the computer program, when executed by a processor, implementing the method provided in any exemplary embodiment of this application.

### BRIEF DESCRIPTION OF THE DRAWINGS

The accompanying drawings described herein are used to provide a further understanding of this application, and form part of this application. Exemplary embodiments of this application and descriptions thereof are used to explain this application, and do not constitute any inappropriate limitation to this application. In the accompanying drawings:

FIG. 1 is a schematic flowchart of an electronic locker control method according to an embodiment of this application.

FIG. 2 is a schematic flowchart of an electronic locker control method for parcel sending according to an embodiment of this application.

FIG. 3 is a schematic flowchart of an electronic locker control method on a payment server side according to an embodiment of this application.

FIG. 4A is a schematic diagram of an electronic locker control system according to an embodiment of this application.

FIG. 4B is a schematic diagram of a scenario of an electronic locker control system according to an embodiment of this application.

FIG. 5 is a flowchart of an interaction between devices in an electronic locker control system according to an embodiment of this application.

FIG. 6A is a schematic diagram of an electronic locker control system for an express scenario according to an embodiment of this application.

FIG. 6B is a schematic structural diagram of an electronic locker control system for an express scenario according to an embodiment of this application.

FIG. 6C is a flowchart of an interaction between devices in an express pickup scenario according to an embodiment of this application.

FIG. 7 is a schematic structural diagram of an electronic locker control apparatus according to an embodiment of this application.

FIG. 8 is a schematic structural diagram of an electronic locker control apparatus according to an embodiment of this application.

FIG. 9 is a schematic structural diagram of an electronic locker according to an embodiment of this application.

FIG. 10 is a schematic structural diagram of an electronic device according to an embodiment of this application.

### DESCRIPTION OF EMBODIMENTS

The embodiments of this application are described in combination with the accompanying drawings of this application. The following implementations described in combination with the accompanying drawings are exemplary descriptions for explaining the technical solutions of the embodiments of this application, and do not limit the technical solutions of the embodiments of this application.

A person skilled in the art may understand that, unless specifically stated, singular forms “a”, “an”, “the”, and “said” used herein may also include plural forms. Terms “include” and “comprise” used in the embodiments of this application mean that corresponding features may be implemented as presented features, information, data, steps, operations, elements, and/or components, but do not exclude implementation as other features, information, data, steps, operations, elements, components, and/or a combination thereof, and the like supported in the art. When an element is referred to as being “connected” or “coupled” to another element, the element may be directly connected or coupled to another element, or may mean that a connection relationship is established between the element and another element by using an intermediate element. In addition, the “connection” or “coupling” used herein may include wireless connection or wireless coupling. A term “and/or” used herein indicates at least one of items limited by the term. For example, “A and/or B” may be implemented as “A”, “B”, or “A and B”. When a plurality of (two or more than two) items are described, if a relationship among the plurality of items is not clearly limited, the plurality of items may refer to one, more, or all of the plurality of items. For example, the description “a parameter A including A1, A2, and A3” may be implemented as that the parameter A includes A1, or A2, or A3, or may be implemented as that the parameter A includes at least two of the three parameters A1, A2, and A3.

In some embodiments, the solutions provided in the embodiments of this application may be implemented based on a cloud technology. For example, the solutions of the embodiments of this application may be performed by the first server (e.g., a payment server), the second server (e.g., a logistics server), or an electronic locker.

The first server and the second server may be cloud servers, data processing involved in an implementation process of the solutions may be implemented based on the cloud technology, and data storage involved in the implementation process may use cloud storage. For example, the second mapping relationship including a correspondence between first object identifiers and second object identifiers of a plurality of objects may be stored in a cloud server, and the third mapping relationship including a correspondence between second object identifiers and first biometric features of a plurality of objects may be stored in the cloud server.

In exemplary embodiments of this application, for relevant data such as involved object information (e.g., biometric features of objects), when the embodiments of this application are applied to a specific product or technology, a permission or agreement of an object is required, and collection, use, and processing of the relevant data need to comply with relevant laws, regulations, and standards of relevant countries and regions. That is, in the embodiments of this application, data related to an object may be acquired only when the data is authorized and agreed by the object, or authorized and agreed by a relevant department, and satisfies relevant laws, regulations, and standards of a country and a region. If personal information is involved in the embodiments, personal agreement needs to be obtained for acquiring all the personal information. For example, if sensitive information is involved, independent agreement of an information subject needs to be acquired. The embodiments also need to be implemented in a case that an object authorizes to agree.

An electronic locker control method provided in an embodiment of this application may be performed by any electronic device, such as a server or an electronic locker. The method may be described from various perspectives, encompassing operations of interactions between different devices, or may also be described from different device sides. For example, regarding interaction operations between the payment server and the electronic locker, the description may be made with the payment server as an executing entity, or alternatively, with the first electronic device (e.g., a processor) within the electronic locker as the executing entity. For example, the payment server transmits the first biometric feature of the first target object to the electronic locker, and correspondingly, the description may also be written as the electronic locker receiving the first biometric feature of the first target object from the payment server.

In the embodiments of this application, the server may be an independent physical server, or may be a server cluster or a distributed system formed by a plurality of physical servers, or may also be a cloud server providing cloud computing services. The server may receive a service processing request (e.g., a payment authorization activation request and a payment authorization binding request) initiated by a user terminal, and process the service processing request. In some embodiments, the server may further return a processing result of the service processing request to the user terminal.

The user terminal in the embodiments of this application may be a smart phone, a tablet computer, a notebook computer, a desktop computer, a smart voice interactive device (e.g., a smart speaker), a wearable electronic device (e.g., a smartwatch), an on board terminal, an intelligent household electrical appliance (e.g., a smart television), an augmented reality (AR)/virtual reality (VR) device, or the like, but is not limited thereto. The user terminal and the server may be connected directly or indirectly in a wired or wireless communication mode, which is not limited in the embodiments of this application.

Currently, when picking up a parcel from the electronic locker (e.g., a self-service express pickup locker), a user may perform identity authentication in a mode of inputting a pickup code on a display screen of the locker or scanning a pickup identifier (e.g., a two-dimensional code or a bar code) by using the user terminal. If the identity authentication succeeds, a corresponding locker door is automatically popped up. If a storage duration of an ordered item exceeds a preset duration, a certain pickup fee needs to be charged. In this case, after completing identity authentication, the user may be prompted that the order has been stored for too long. The user needs to exit a current interface, and rescan a payment code to make a payment, and only after the payment is completed will the locker door open.

Evidently, when the user picks up a timeout parcel, the user needs to perform two operations: identity authentication and code scanning payment to complete the pickup, resulting in a redundant and complex operation process and low pickup efficiency. Especially, when a large quantity of users queue up for pickup, the users wait for a long time, resulting in poor experience.

To solve at least one of the foregoing problems, in the method provided in this embodiment of this application, identity authentication and payment may be simultaneously completed based on a biometric feature of the user, and a stored biometric feature of the user is distributed to the electronic locker in advance. When the user picks up a parcel, matching authentication is performed based on the biometric feature at an electronic locker end. In a case that the user is not perceived, identity authentication and payment are integrated during a pickup process, the pickup process is shortened, a problem that the user picks up the timeout parcel can be effectively solved, the pickup efficiency is improved, and user experience is greatly improved.

An embodiment of this application provides an electronic locker control method. The technical solution provided in each embodiment of this application is described in detail below in combination with the accompanying drawings.

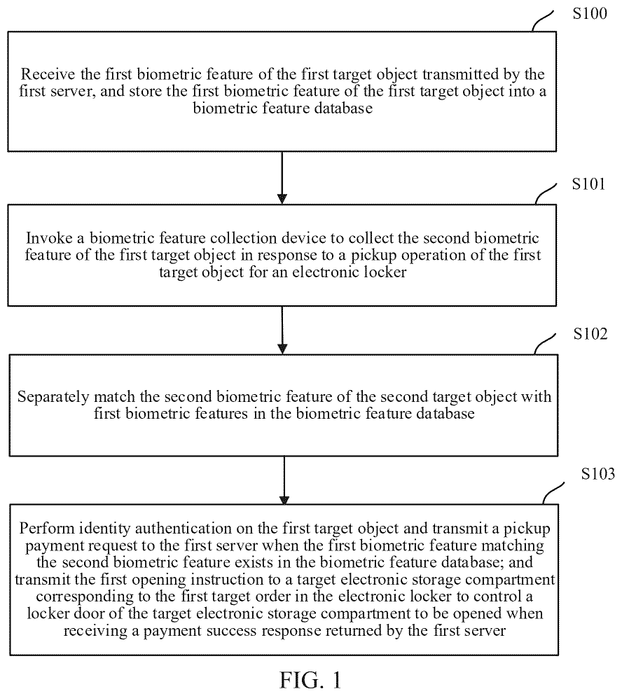

When the user picks up a parcel from the electronic locker, the electronic locker needs to perform identity authentication on the user. When an ordered item is stored for too long, the user needs to pay a related fee. In this case, a payment end also needs to perform identity authentication on the user. Therefore, an embodiment of this application provides an electronic locker control method, as shown in FIG. 1. FIG. 1 is a schematic flowchart of an electronic locker control method according to an embodiment of this application. The method is used for pickup, and may be performed by the first electronic device (e.g., a processor) connected to an electronic locker as an executing entity. The electronic locker is configured with a biometric feature collection device and a plurality of electronic storage compartments. The following operations may be specifically included.
Operation S100: Receive the first biometric feature of the first target object transmitted by the first server, and store the first biometric feature of the first target object into a biometric feature database.

In this operation, the first server is a payment server.

The electronic locker may acquire a biometric feature uniquely identifying an identity of a user from the payment server in advance. When the user subsequently picks up a parcel, matching may be performed based on a biometric feature of the user collected in real time and the biometric feature acquired from the payment server, such that after identity authentication succeeds and in a case that the user is not perceived, the biometric feature is transmitted to the payment server to complete payment.

Specifically, when determining that the first target order of the first target object is already placed into the electronic locker, the second server transmits the first notification message to the payment server.

The second server is a server corresponding to the electronic locker. The electronic locker may be a self-service express pickup locker, a self-service takeout locker, a mall locker, a gym locker, or the like. Correspondingly, the second server may be a logistics server, a takeout server, or the like.

The first target object may be any user that stores an item through the electronic locker. The first target order is a logistics order in which the first target object uses the electronic locker to store the item. Placing the first target order into the electronic locker means placing the item in the first target order into the electronic locker. For ease of description, “placing the first target order into the electronic locker” is described subsequently.

In this embodiment of this application, the second server may determine, through the following mode, that the first target order of the first target object is already placed into the electronic locker: after the third object places the item in the first target order of the first target object into the electronic locker, the third object may transmit order status information to the second server through the third terminal or the electronic locker for placement.

The third object is a user placing the item, such as an express dispatcher or a takeout rider.

The order status information at least includes a placement completion time of the item in the first target order and a locker identifier of the electronic locker for placement, or may also include an order identifier of the first target order, the first object identifier of the first target object, an identifier of a target electronic storage compartment in which the item in the first target order is stored in the electronic locker, and the like.

The second server may determine, according to received order status information, that the first target order is already placed into the electronic locker.

In this embodiment of this application, the first notification message includes the second object identifier of the first target object and the locker identifier of the electronic locker into which the first target order is placed. The first notification message is generated by the second server in the following mode: determining, based on the first object identifier of the first target object and the second mapping relationship, the second object identifier of the first target object stored in the first server when determining that the first target order is placed into the electronic locker, the second mapping relationship including a correspondence between first object identifiers and second object identifiers of a plurality of objects. The first notification message is generated based on a determined second object identifier and the locker identifier of the electronic locker into which the first target order is placed.

The second server has the first object identifier of the first target object stored therein, and the first object identifier is configured for storing orders in the electronic locker. That is, the first object identifier of the first target object is a corresponding object identifier of the first target object within the second server, and is configured for associating objects and orders.

The first server (e.g., the payment server) has the first object identifier of the first target object stored therein, and the first object identifier is configured for paying pickup costs of each order. That is, the second object identifier is a corresponding object identifier of the first target object within the payment server, and is configured for associating objects with payment behaviors.

In this embodiment of this application, the second mapping relationship is stored after the user performs payment authorization binding. The user terminal transmits a payment authorization binding request to the second server in response to a payment authorization binding operation triggered by the first target object. The payment authorization binding request includes the first object identifier and the second object identifier of the first target object, for authorizing the first server to transmit the first biometric feature of the first target object to the second server. The second server receives the payment authorization binding request transmitted by the user terminal, associatively stores the first object identifier and the second object identifier of the first target object into the second mapping relationship based on a received payment authorization binding request.

In some embodiments, the user terminal may also transmit the payment authorization binding request to the payment server, and the payment server forwards the payment authorization binding request to the second server.

In some embodiments, the user terminal may also transmit the payment authorization binding request to the payment server, and the payment server associatively stores the first object identifier and the second object identifier of the second object into the second mapping relationship based on the received payment authorization binding request. A storage location of the second mapping relationship is not limited in this application, and may be set as needed.

When receiving the first notification message, the payment server transmits the first biometric feature of the first target object to the electronic locker corresponding to the first notification message. The biometric feature refers to an inherent physiological feature of a human body, such as a human face, a fingerprint, a voiceprint, an iris, a hand shape, or a palm print, and can uniquely represent an identity of a user.

In this embodiment of this application, the payment server has first biometric features of a plurality of objects and the third mapping relationship stored therein. The third mapping relationship includes a correspondence between second object identifiers and the first biometric features of the plurality of objects. The payment server determines the first biometric feature of the first target object in stored first biometric features of the objects according to the second object identifier in the first notification message and the third mapping relationship, and then transmits, according to the locker identifier of the electronic locker in the first notification message, the first biometric feature of the first target object to the electronic locker into which the first target order is placed.

The third mapping relationship is stored by the payment server after payment authorization of the user is activated. The user terminal invokes an image collection device (e.g., a biometric feature collection device) configured on the electronic locker to collect a biometric feature image of the first object in response to a payment authorization activation operation triggered by the first target object, and transmits a payment authorization activation request to the payment server.

The payment authorization activation operation may be operated on a payment application running on the user terminal, and the payment application is an application corresponding to the payment server.

The biometric feature collection device configured on the user terminal may be a camera, a fingerprint collector, or the like. The biometric feature image may be an image including a physiological feature, such as a face image, a fingerprint image, a palm print image, or a human eye image.

The payment authorization activation request includes the second object identifier and a biometric feature image of the first target object. The payment server extracts the first biometric feature of the first target object from the biometric feature image in the payment authorization request, and associatively stores the second object identifier in the payment authorization activation request and an extracted first biometric feature into the third mapping relationship.

When the image collection device configured on the user terminal collects biometric feature images, the biometric feature collection device may collect a plurality of biometric feature images, determine a quality score of each biometric feature image based on a preset image quality evaluation index, and transmit a biometric feature image with the highest quality score to the payment server for feature extraction. The image quality evaluation index at least includes one of image contrast, image brightness, image definition, a size of a biometric feature in an image, or an angle of a biometric feature in an image.

The payment authorization activation involves authorizing the payment server to store the first biometric feature of the object, so as to perform payment based on the biometric feature during subsequent payment. The payment authorization binding involves authorizing the payment server to transmit the first biometric feature to the second server. Therefore, the payment authorization binding can be performed only after the payment authorization activation for the object.

The electronic locker receives the first biometric feature of the first target object transmitted by the payment server and stores the first biometric feature of the first target object into a local biometric feature database of the electronic locker.

In some embodiments, the electronic locker may associatively store the first biometric feature of the first target object and the first object identifier of the first target object into the biometric feature database.

In some embodiments, the first biometric feature transmitted by the payment server carries the second object identifier of the first target object, and the electronic locker determines the first object identifier of the first target object based on the second object identifier of the first target object and the second mapping relationship, and associatively stores the first biometric feature and the first object identifier of the first target object into the local biometric feature database of the electronic locker.

The second mapping relationship stored on the electronic locker side may include a correspondence between first object identifiers and second object identifiers of all objects, or may include only a correspondence between the first object identifier and the second object identifier of each first target object in an order already placed into the electronic locker.

When the second mapping relationship stored on the electronic locker side includes the correspondence between the first object identifiers and the second object identifiers of all the objects, the second mapping relationship may be locally pre-stored in the electronic locker, or may be acquired from the second server.

When the second mapping relationship stored on the electronic locker side includes only the correspondence between the first object identifier and the second object identifier of each first target object in the order already placed into the electronic locker, the electronic locker may poll the second server for the second mapping relationship corresponding to each order already placed into the electronic locker. The second server determines, according to each order already placed into the electronic locker, the first target object corresponding to each order already placed and a correspondence between the first object identifier and the second object identifier of each first target object, and transmits the correspondence between the first object identifier and the second object identifier of each order already placed into the electronic locker.

In this embodiment of this application, because the electronic locker is usually placed at a corner location of a residential community or an office building, and a network signal around is poor, to shorten a waiting duration when the first target object picks up a parcel and improve the pickup efficiency of the user, the second server may transmit the first notification message to the payment server after placement of the first target order is completed, such that the payment server distributes the first biometric feature of the first target object to the electronic locker, to ensure that the electronic locker locally stores the first biometric feature of the first target object when the first target object arrives at the electronic locker for pickup, without the need for real-time acquisition from the payment server, so as to shorten the waiting duration of the first target object. Especially in a case that the network signal is poor, the pickup efficiency is greatly improved, and user experience is improved.
Operation S101: Invoke a biometric feature collection device to collect the second biometric feature of the first target object in response to a pickup operation of the first target object for an electronic locker.

When the first target object arrives at the electronic locker for pickup, the electronic locker invokes, in response to the pickup operation of the first target object, the biometric feature collection device configured on the electronic locker to collect the second biometric feature of the first target object.

The electronic locker is configured with at least one biometric feature collection device. When collecting the second biometric feature, the electronic locker may invoke the biometric feature collection device specified by the first target object to perform collection.

In this embodiment of this application, the pickup operation may be a tap operation on a locker display screen of the electronic locker, such as tapping “I want to pick up a parcel”, or may be a specified action, such as placing a palm right above the camera.

After determining that the first target order is already placed into the electronic locker, the second server may push the order status information of the first target order to a terminal of the first target object, where the order status information at least includes the locker identifier of the electronic locker into which the first target order is placed, to prompt the first target object to head for the electronic locker for pickup.

During collection of the biometric feature image through the biometric feature collection device configured on the electronic locker, a plurality of biometric feature images may be acquired, and a quality score of each biometric feature image is determined based on a preset image quality evaluation index, and the second biometric feature of the first target object is extracted according to the biometric feature image with the highest quality score. The image quality evaluation index includes at least one of image contrast, image brightness, image definition, a size of a biometric feature in an image, or an angle of a biometric feature in an image.
Operation S102: Separately match the second biometric feature of the first target object with first biometric features in the biometric feature database.
Operation S103: Perform identity authentication on the first target object and transmit a pickup payment request to the first server when the first biometric feature matching the second biometric feature exists in the biometric feature database; and transmit the first opening instruction to a target electronic storage compartment corresponding to the first target order in the electronic locker to control a locker door of the target electronic storage compartment to be opened when receiving a payment success response returned by the first server.

In this operation, if the first biometric feature matching the second biometric feature of the first target object exists in the biometric feature database, a pickup cost, namely a pickup fee, of the first target order is determined, and a fee deduction operation is performed based on the pickup fee through the payment server, and when the deduction succeeds, the locker door of the target electronic storage compartment corresponding to the first target order is controlled to be opened.

After collecting the second biometric feature of the first target object in real time, the electronic locker may perform identity authentication on the first target object. The second biometric feature of the first target object is separately matched with each pre-stored first biometric feature in the biometric feature database.

If the first biometric feature matching the second biometric feature of the first target object exists in the biometric feature database, the identity authentication succeeds, and the electronic locker has a parcel to be picked up for the first target object. In this case, the first object identifier associated with the first biometric feature matching the second biometric feature is determined, and a pickup cost corresponding to a determined first object identifier, namely the pickup cost of the first target order is obtained by querying based on the first mapping relationship. The pickup cost of the order is positively correlated to a storage duration of an item in the order. The first mapping relationship is a correspondence between first object identifiers corresponding to orders already placed into the electronic locker and pickup costs.

In some embodiments, the locker may charge fees according to a storage duration, such as charging per unit of time or charging per unit of time only after the storage exceeds a certain duration.

The electronic locker may poll the second server for the pickup cost of each order already placed into the electronic locker. The second server determines the pickup cost of each order based on a preset charging rule and a storage duration of each placed order, and returns the pickup cost to the electronic locker. The electronic locker updates and stores the first mapping relationship based on the most recently received pickup costs for orders.

In some embodiments, the pickup cost for each order already placed into the electronic locker may also be calculated by the electronic locker based on the storage duration of each placed order and the preset charging rule.

After successful feature matching, the electronic locker may transmit the pickup payment request, namely a fee deduction request to the payment server based on the pickup cost of the first target order, and the payment server performs fee deduction according to the pickup fee in the received fee deduction request and returns deduction feedback information to the electronic locker.

After determining that the deduction is successful according to the deduction feedback information, the electronic locker determines the target electronic storage compartment corresponding to the first target order, namely, the electronic storage compartment where the item in the first target order is stored in the electronic locker, and transmits the first opening instruction to the target electronic storage compartment to control the locker door of the target electronic storage compartment to be opened.

Before the fee deduction request is transmitted to the payment server, if the pickup fee of the first target order is 0, no fee is charged when the pickup is within a time limit, and there is no need to request deduction from the payment server. Instead, the first opening instruction is directly transmitted to the target electronic storage compartment to control the opening of the locker door corresponding to the first target order.

If the first biometric feature matching the second biometric feature of the first target object does not exist in the biometric feature database, the identity authentication fails, and the electronic locker does not have a parcel to be picked up for the first target object.

If the locker door of the target electronic storage compartment is not opened, the first target object may still assist in pickup in modes such as inputting a pickup code on the display screen of the locker.

In this embodiment of this application, the first target object may have a plurality of parcels to be picked up in the same electronic locker. Therefore, to facilitate pickup, when the first target object performs pickup from the electronic locker, the electronic locker may query, according to the first object identifier associated with the matching first biometric feature, whether the first target object has other parcels to be picked up in the electronic locker. When receiving order status information for other parcels to be picked up of the first target object in the electronic locker returned by the second server, the order status information is displayed on a locker display screen of the electronic locker to prompt the first target object to continue picking up the parcels from the electronic locker.

In this embodiment of this application, considering that the first target object may have other parcels to be picked up that are stored at nearby alternative collection points or relay stations, for example, the first target order is stored in the electronic locker, while the third target order is stored at another collection point or relay station. To prevent the first target object from heading to different locations for pickup and improve the pickup efficiency, before the first target object heads for pickup, the first target object may further modify a delivery point of the third target order, such that the third object forwards the third target order to the electronic locker in which the first target order is stored.

Specifically, when receiving order status information of the third target order, the user terminal transmits, in response to a delivery point modification operation of the first target object, a delivery point modification request corresponding to the third target order to the second server, where the delivery point modification request carries the locker identifier of the electronic locker into which the first target order is placed. The second server transmits order delivery point modification information of the third target order to the third terminal of the third object according to a received delivery point modification request, such that the third object places, from another nearby collection point or collection station, the third target order to the electronic locker in which the first target order is stored.

When the first target object goes to the electronic locker for pickup, the electronic locker invokes, in response to the pickup operation of the first target object, the biometric feature collection device to collect the second biometric feature of the first target object, and matches the second biometric feature of the first target object with the first biometric features in the biometric feature database. If the biometric feature database has the first biometric feature matching the collected second biometric feature, all orders to be picked up (including the first target order and the forwarded third target order) corresponding to the first object identifier in the electronic locker are queried based on the first object identifier associated with the matching first biometric feature, and all the orders to be picked up that correspond to the first object identifier are displayed on the locker display screen of the electronic locker, to prompt the first target object whether to select an order for pickup.

If the first target object proceeds with pickup, the electronic locker determines, in response to a selection operation of the first target object on the orders to be picked up on the locker display screen, a total pickup fee for all orders to be picked up that are selected by the first target object. Based on the total pickup fee for all the orders to be picked up, the payment server performs the fee deduction operation, and when the deduction is successful, locker doors of target electronic storage compartments corresponding to the orders to be picked up are controlled to be opened.

In this embodiment of this application, when the first target object performs pickup from the electronic locker, the electronic locker may further transmit an order query request to the second server according to the first object identifier associated with the matching first biometric feature, to query whether the first target object has other parcels to be picked up at another nearby collection point or relay station. When receiving order status information for other parcels to be picked up of the first target object returned by the second server, the order status information is displayed on the locker display screen of the electronic locker to prompt the first target object whether to redirect other parcels to be picked up to the electronic locker.

In some embodiments, the order query request may be configured for querying for other parcels to be picked up of the first target object within a preset range around the electronic locker. The second server may query, according to the first object identifier in the order query request, for other parcels to be picked up corresponding to the first object identifier, and determine, according to the locker identifier of the electronic locker and order delivery points of the other parcels to be picked up in the order query request, the other parcels to be picked up with the order delivery points within the preset range of the electronic locker, and distribute order status information of determined other parcels to be picked up to the electronic locker for displaying. The preset range may be set as needed, such as within a 500-meter radius of the electronic locker, which is not limited in this specification.

Based on the electronic locker control method shown in FIG. 1, the electronic locker acquires the pre-stored first biometric feature of the first target object from the payment server, collects the second biometric feature of the first target object in real time when the first target object performs pickup, matches the second biometric feature with the pre-stored first biometric features, performs identity authentication on the first target object through biometric feature matching, requests the payment server to perform fee deduction after the authentication succeeds, and controls the locker door of the target electronic storage compartment corresponding to the first target order to be opened when the deduction succeeds. In a case that security is ensured and the user is not perceived, identity authentication and payment are integrated during the pickup process, thereby improving the pickup efficiency.

In addition, the electronic locker control method in this embodiment of this application for identity authentication and payment based on the biometric features reduces dependency on the user terminal, such that the user can achieve pickup without carrying the terminal, thereby better meeting an actual application requirement.

In this embodiment of this application, when the electronic locker is used for parcel sending, integration of identity authentication and payment may also be achieved based on biometric feature matching.

The following is a detailed description of a parcel sending method provided in an embodiment of this application in combination with the accompanying drawings.

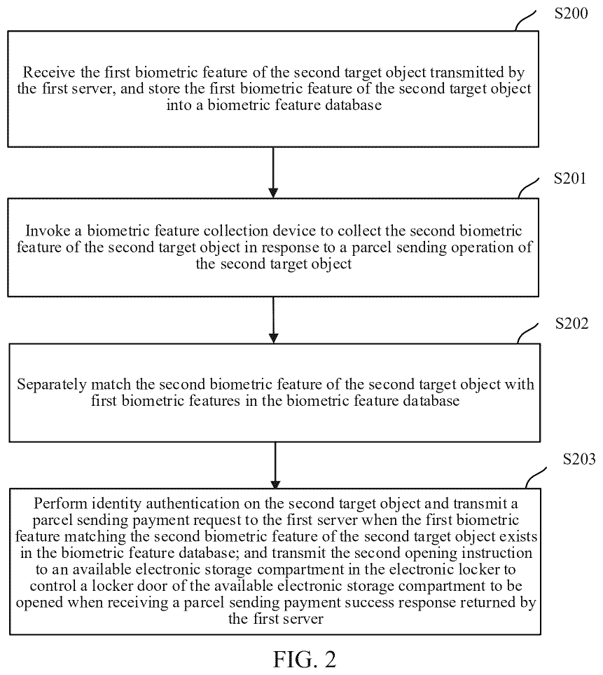

FIG. 2 is a schematic flowchart of an electronic locker control method according to an embodiment of this application. The method is used for parcel sending, and is performed by the first electronic device. The first electronic device is connected to an electronic locker, and the electronic locker is configured with a biometric feature collection device and a plurality of electronic storage compartments. Specifically, the following operations may be included:
Operation S200: Receive the first biometric feature of the second target object transmitted by the first server, and store the first biometric feature of the second target object into a biometric feature database.

Specifically, when receiving a parcel sending request of the second target order that is transmitted by the second target object through a terminal, the second server transmits the second notification message to a payment server. The second target object is any user for parcel sending through the electronic locker.

In some embodiments, the second notification message includes the second object identifier of the second target object and a locker identifier of the electronic locker selected by the second target object, and is generated by the second server in the following mode: when receiving the parcel sending request of the second target object that is transmitted by the terminal, the second server determines the second object identifier of the second target object based on the first object identifier of the second target object and the second mapping relationship, and generates the second notification message based on the determined second object identifier and the locker identifier of the electronic locker in the parcel sending request.

In some embodiments, the parcel sending request is generated by a terminal of the second target object in the following mode: displaying an electronic locker list in response to a parcel sending operation triggered by the second target object. The electronic locker list includes a locker identifier of at least one electronic locker. Then, an electronic locker selected by the second target object is determined in response to a selection operation of the second target object on the locker identifier in the locker list, and the parcel sending request is generated according to the electronic locker selected by the second target object and the first object identifier.

When receiving the second notification message, the payment server transmits the first biometric feature of the second target object to the electronic locker corresponding to the second notification message.

In some embodiments, the payment server determines the first biometric feature of the second target object from stored first biometric features of objects according to the second object identifier in the second notification message and the third mapping relationship, and then transmits, according to the locker identifier of the electronic locker in the second notification message, the first biometric feature of the second target object to the electronic locker selected by the second target object.

The electronic locker receives the first biometric feature of the second target object that is transmitted by the payment server and stores the first biometric feature of the second target object into the biometric feature database.

In some embodiments, the electronic locker may associatively store the first biometric feature of the second target object and the first object identifier of the second target object into the biometric feature database.

In some embodiments, the first biometric feature transmitted by the payment server carries the second object identifier of the second target object, and the electronic locker determines the first object identifier of the second target object based on the second object identifier of the second target object and the second mapping relationship, and associatively stores the first biometric feature and the first object identifier of the first target object into the local biometric feature database of the electronic locker.
Operation S201: Invoke a biometric feature collection device to collect the second biometric feature of the second target object in response to a parcel sending operation of the second target object.

When the second target object arrives at the electronic locker for parcel sending, the electronic locker invokes, in response to the parcel sending operation of the second target object, the biometric feature collection device configured on the electronic locker to collect the second biometric feature of the second target object.

In this embodiment of this application, the parcel sending operation may be a tap operation on a locker display screen of the electronic locker, such as tapping “I want to send a parcel”, or may be a specified action, such as placing a palm right above the camera.
Operation S202: Separately match the second biometric feature of the second target object with first biometric features in the biometric feature database.
Operation S203: Perform identity authentication on the second target object and transmit a parcel sending payment request to the first server when the first biometric feature matching the second biometric feature of the second target object exists in the biometric feature database; and transmit the second opening instruction to an available electronic storage compartment in an electronic locker to control a locker door of the available electronic storage compartment to be opened when receiving a parcel sending payment success response returned by the first server.

In this operation, if the first biometric feature matching the second biometric feature of the second target object exists in the biometric feature database, a parcel sending cost, namely a parcel sending fee, of the second target order is determined, and a fee deduction operation is performed based on the parcel sending fee through the payment server, and when the deduction succeeds, the locker door of the available electronic storage compartment is controlled to be opened.

After collecting the second biometric feature of the second target object in real time, the electronic locker may perform identity authentication on the second target object. The second biometric feature of the second target object is separately matched with each pre-stored first biometric feature in the biometric feature database.

If the first biometric feature matching the second biometric feature of the second target object exists in the biometric feature database and the identity authentication succeeds, the first object identifier associated with the first biometric feature matching the second biometric feature is determined, and a parcel sending fee corresponding to the determined first object identifier is obtained by querying based on the first mapping relationship as the parcel sending fee of the second target order. The second target order is a parcel sending order of the second target object.

The electronic locker transmits a fee deduction request to the payment server based on the parcel sending fee of the second target order. The payment server performs fee deduction according to the parcel sending fee in the received fee deduction request, and returns deduction feedback information to the electronic locker. After determining successful deduction according to the deduction feedback information, the electronic locker queries for available electronic storage compartments in the electronic locker, and controls a locker door of any available electronic storage compartment to be opened.

Specific operations performed by each of the payment server, the electronic locker, and the second server and establishment of the mapping relationships have been described in detail above. Details are not described herein again in this application, and reference may be made to the content in the foregoing operations S100 to S103.

In this embodiment of this application, when the second target object arrives at the electronic locker for parcel sending, the electronic locker may further query whether the second target object still has parcels to be picked up, to prompt the second target object for pickup. Specifically, when the biometric feature database has the first biometric feature matching the second biometric feature of the second target object, whether the electronic locker has orders to be picked up corresponding to the first object identifier may be queried based on the first object identifier associated with the matching first biometric feature, and when the orders to be picked up corresponding to the first object identifier exist, pickup prompt information is displayed on the locker display screen of the electronic locker.

In some embodiments, the electronic locker prompts, based on the displayed pickup prompt information, the second target object whether to pick up parcels, and performs pickup through the electronic locker control method including the foregoing shown operations S100 to S103 when receiving the pickup operation of the second target object.

Based on the parcel sending method shown in FIG. 2, the electronic locker acquires the pre-stored first biometric feature of the second target object from the payment server, and collects the second biometric feature of the second target object in real time when the second target object sends parcels, matches the second biometric feature with the pre-stored first biometric features, performs identity authentication on the second target object through biometric feature matching, requests the payment server to perform fee deduction after the authentication succeeds, and controls the locker door of the available electronic storage compartment to be opened when the deduction succeeds. In a case that security is ensured and the user is not perceived, identity authentication and payment are integrated during the parcel sending process, thereby improving the parcel sending efficiency.

In addition, the parcel sending method in this embodiment of this application for identity authentication and payment based on the biometric features reduces dependency on the user terminal, such that the user can achieve parcel sending without carrying the terminal, so as to better meet an actual application requirement.

In this embodiment of this application, the first object identifier corresponding to any second object in the second server may be the same as the second object identifier corresponding to the second object in the payment server, for example, by using a unified identifier pre-agreed upon by the second server and the payment server. In this case, there is no need to establish the second mapping relationship.

In this embodiment of this application, because the biometric feature is personal privacy data of the user, to ensure security of data transmission, technical means such as encryption and identity authentication may be used to assist in transmission.

When the first biometric feature is transmitted from the payment server to the electronic locker, encryption processing may be performed on the first biometric feature. For example, the transmitted first biometric feature is encrypted by using an asymmetric encryption algorithm, the payment server encrypts the transmitted first biometric feature by using a public key, and the electronic locker decrypts the encrypted first biometric feature by using a private key.

In an embodiment, after receiving the first notification message transmitted by the second server, the payment server may perform identity authentication on a merchant according to a merchant identifier in the first notification message, determine whether the merchant is an authorized and bound merchant, and then transmit the first biometric feature to an electronic locker corresponding to the merchant after the identity authentication succeeds.

After the electronic locker controls the locker door of the target electronic storage compartment to be opened, the first biometric feature of the first target object is deleted from the local biometric feature database in response to the locker door of the target electronic storage compartment being closed.

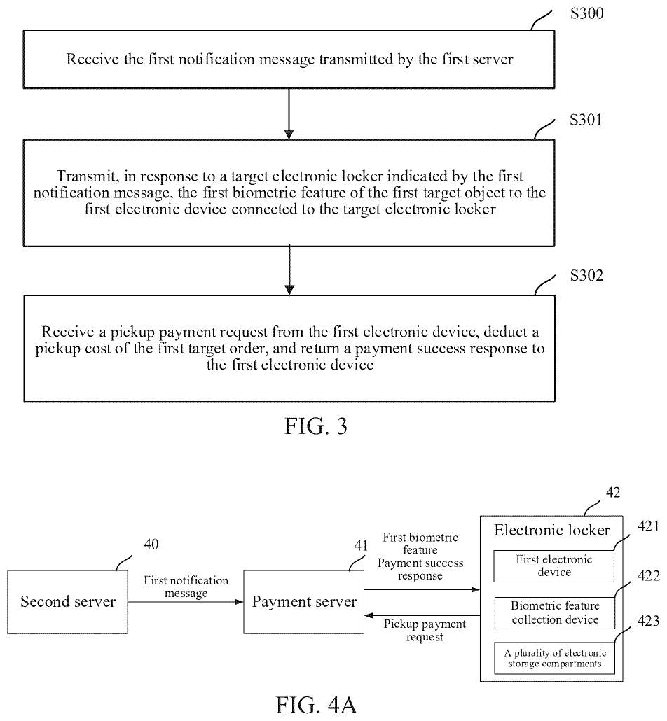

FIG. 3 is a schematic flowchart of an electronic locker control method according to an embodiment of this application. The electronic locker control method may be performed by the first server (e.g., a payment server) as an executing entity, and specifically includes the following operations:
Operation S300: Receive the first notification message transmitted by the second server.

Specifically, when determining that the first target order of the first target object is already placed into the electronic locker, the second server transmits the first notification message to the payment server.

The payment server receives the first notification message transmitted by the second server. The first notification message includes the second object identifier of the first target object and a locker identifier of a target electronic locker into which the first target order is placed, for instructing the payment server to distribute the first biometric feature to the target electronic locker indicated by the first notification message.
Operation S301: Transmit, in response to a target electronic locker indicated by the first notification message, the first biometric feature of the first target object to the first electronic device connected to the target electronic locker, such that the first electronic device performs the following operation: storing the first biometric feature of the first target object into a biometric feature database; invoking a biometric feature collection device to collect the second biometric feature of the first target object in response to a pickup operation of the first target object for the target electronic locker; and performing identity authentication on the first target object and transmitting a pickup payment request when the first biometric feature matching the second biometric feature exists in the biometric feature database.

In some embodiments, the payment server has first biometric features of a plurality of objects and the third mapping relationship stored therein. The third mapping relationship includes a correspondence between second object identifiers and the first biometric features of the plurality of objects. The payment server determines the first biometric feature of the first target object from the stored first biometric features of the objects according to the second object identifier in the first notification message and the third mapping relationship, and then transmits, according to the locker identifier of the electronic locker indicated in the first notification message, the first biometric feature of the first target object to the first electronic device connected to the target electronic locker.

After the payment server distributes the first biometric feature of the first target object to the first electronic device, the first electronic device may store the received first biometric feature of the first target object into the biometric feature database. The first biometric feature of the first target object and the first object identifier of the first target object may be associatively stored.

The first biometric feature transmitted by the payment server carries the second object identifier of the first target object, and the first electronic device determines the first object identifier of the first target object based on the second object identifier of the first target object and a local second mapping relationship, and associatively stores the first biometric feature and the first object identifier of the first target object into the local biometric feature database of the target electronic locker.

When the first target object arrives at the target electronic locker for pickup, the first electronic device invokes, in response to the pickup operation of the first target object, the biometric feature collection device configured on the target electronic locker to collect the second biometric feature of the first target object. And the collected second biometric feature is separately matched with the first biometric features in the biometric feature database.

If the first biometric feature matching the second biometric feature of the first target object exists in the biometric feature database, the identity authentication succeeds, and based on a pickup fee of the first target order, the payment server performs a fee deduction operation, and controls a locker door of a target electronic storage compartment corresponding to the first target order to be opened when the deduction succeeds.

After the identity authentication succeeds, the first electronic device may determine the first object identifier associated with the first biometric feature matching the second biometric feature, and determine, based on the first mapping relationship, a pickup fee corresponding to the determined first object identifier obtained by querying as the pickup fee of the first target order.
S302: Receive the pickup payment request from the first electronic device, deduct a pickup cost of the first target order, and return a payment success response to the first electronic device, such that the first electronic device transmits, in response to the payment success response, the first opening instruction to a target electronic storage compartment corresponding to the first target order in the target electronic locker, to control a locker door of the target electronic storage compartment to be opened.

Specifically, the payment server performs fee deduction according to the pickup fee included in the received fee deduction request and returns deduction feedback information to the electronic locker. After determining that the deduction is successful according to the deduction feedback information, the electronic locker determines the target electronic storage compartment corresponding to the first target order, namely, the electronic storage compartment where an item in the first target order is stored in the electronic locker, and controls the locker door of the target electronic storage compartment to be opened.

Operations S300 to S302 are involved in the electronic locker control method performed by the payment server as the executing entity, and the involved content such as specific pickup operations of device ends and establishment of mapping relationships have been described in detail above. Details are not described herein again in this application, and reference may be made to details of the foregoing operations S100 to S103.

Based on the electronic locker control method shown in FIG. 3, in a case that security is ensured and the user is not perceived, identity authentication and payment are integrated during the pickup process, thereby improving the pickup efficiency. In addition, the electronic locker control method in this embodiment of this application for identity authentication and payment based on the biometric features reduces dependency on the user terminal, such that the user can achieve pickup without carrying the terminal, thereby better meeting an actual application requirement.

Based on the foregoing electronic locker control method, an embodiment of this application further provides an electronic locker control system.

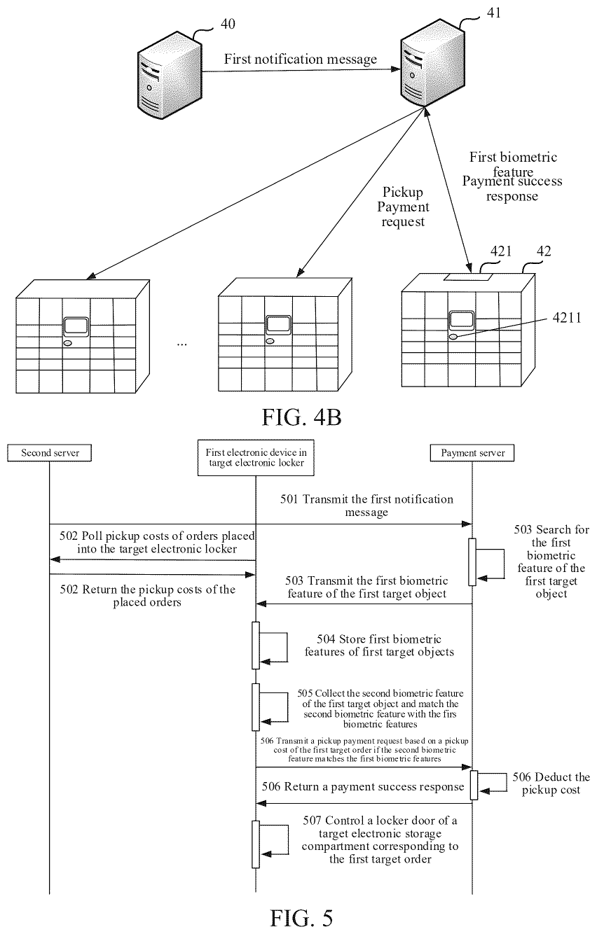

FIG. 4A is a schematic diagram of an electronic locker control system according to an embodiment of this application. The electronic locker control system includes the second server 40, at least one electronic device 421 connected to at least one electronic locker 42, and a payment server 41. The second server 40, the at least one electronic device 421, and the payment server 41 communicate with each other pairwise. A biometric feature collection device 422 and a plurality of electronic storage compartments 423 are configured on each electronic locker 42. The payment server 41 has first biometric features of a plurality of objects stored therein.

FIG. 4B is a schematic diagram of a scenario of an electronic locker control system according to an embodiment of this application. A plurality of electronic lockers are provided in the electronic locker control system. When determining that the first target order of the first target object is already placed into the first electronic device 421 in the target electronic locker 42, the second server 40 transmits the first notification message to the payment server 41.

The payment server 41 transmits the first biometric feature of the first target object to the first electronic device 421 in response to the first notification message.

The first electronic device 421 receives the first biometric feature of the first target object transmitted by the payment server 41, and associatively stores the first biometric feature and the first object identifier of the first target object into a biometric feature database.

When the first target object arrives at the target electronic locker 42 for pickup, the first electronic device 421 invokes, in response to a pickup operation of the first target object, the biometric feature collection device 4211 configured on the target electronic locker 42 to collect the second biometric feature of the first target object.

The second biometric feature is separately matched with first biometric features in the biometric feature database. If the first biometric feature matching the second biometric feature of the first target object exists in the biometric feature database, a pickup payment request is transmitted to the payment server 41 based on a pickup cost of the first target order, and when determining successful deduction according to a payment success response returned by the payment server 41, a locker door of a target electronic storage compartment corresponding to the first target order is controlled to be opened.

Specific operations separately performed by the electronic locker, the second server, and the payment server in the electronic locker control system have been described in detail above. Details are not described herein again in this application, and reference may be made to details of the foregoing operations S100 to S103.

Based on the electronic locker control system provided in FIG. 4A, in a case that security is ensured and the user is not perceived, identity authentication and payment are integrated during the pickup process, thereby improving the pickup efficiency. In addition, the electronic locker control method in this embodiment of this application for identity authentication and payment based on the biometric features reduces dependency on the user terminal, such that the user can achieve pickup without carrying the terminal, thereby better meeting an actual application requirement.

FIG. 5 is a flowchart of an interaction between devices in an electronic locker control system according to an embodiment of this application. The following operations are specifically included:
501: Transmit the first notification message to a payment server when the second server determines that the first target order of the first target object is already placed into a target electronic locker.

The first notification message includes the second object identifier of the first target object and a locker identifier of the target electronic locker.
502: The first electronic device in the target electronic locker polls the second server for pickup costs of placed orders, and receives the pickup costs of the placed orders that are returned by the second server.
503: The payment server queries for the first biometric feature of the first target object based on the first notification message, and transmits the first biometric feature to the first electronic device.
504: The first electronic device stores the first biometric feature of the first target object into a biometric feature database.
505: The first electronic device invokes, in response to a pickup operation of the first target object, a biometric feature collection device to collect the second biometric feature of the first target object and matches a collected second biometric feature with the first biometric features in the biometric feature database.
506: Transmit a pickup payment request to the payment server based on a pickup cost of the first target order if the first biometric feature matching the second biometric feature exists in the biometric feature database, and return a payment success response after the payment server deducts the pickup cost from an account of the first target object.
507: The first electronic device transmits, in response to the payment success response, the first opening instruction to a target electronic storage compartment corresponding to the first target order, and controls a locker door of the target electronic storage compartment to be opened.

To better understand and illustrate the method provided by the embodiments of this application, exemplary implementations of the method provided by this application will be illustrated below in combination with a specific scenario embodiment. In this scenario embodiment, an express pickup scenario of a user A is used as an example for description. A payment server 601 is a server corresponding to a payment application installed in a terminal, and the second server may be a logistics server 602 corresponding to an express merchant. The electronic locker may be a self-service express pickup locker 603, the biometric feature configured for identity authentication may be a palm print feature, and the biometric feature collection device (an image collection device) configured on the self-service express pickup locker may be a three-dimensional (3D) camera.

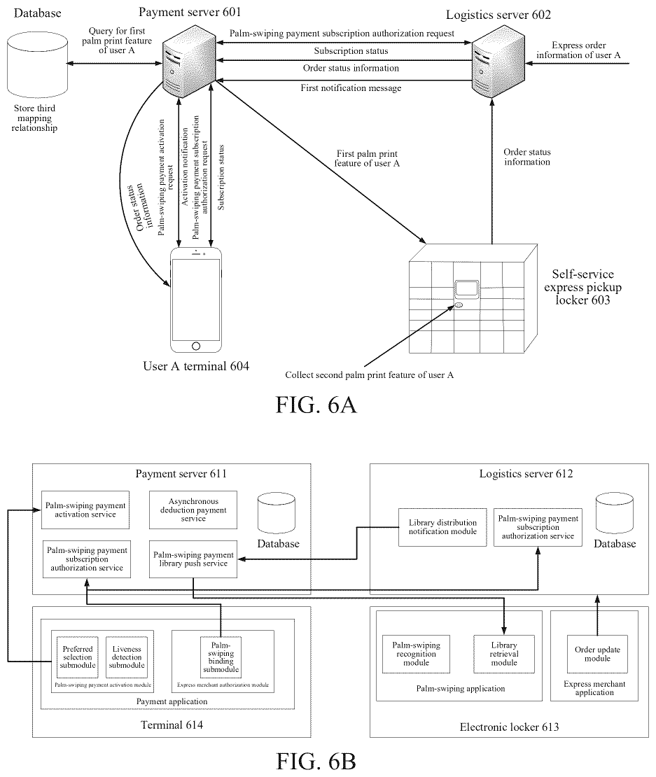

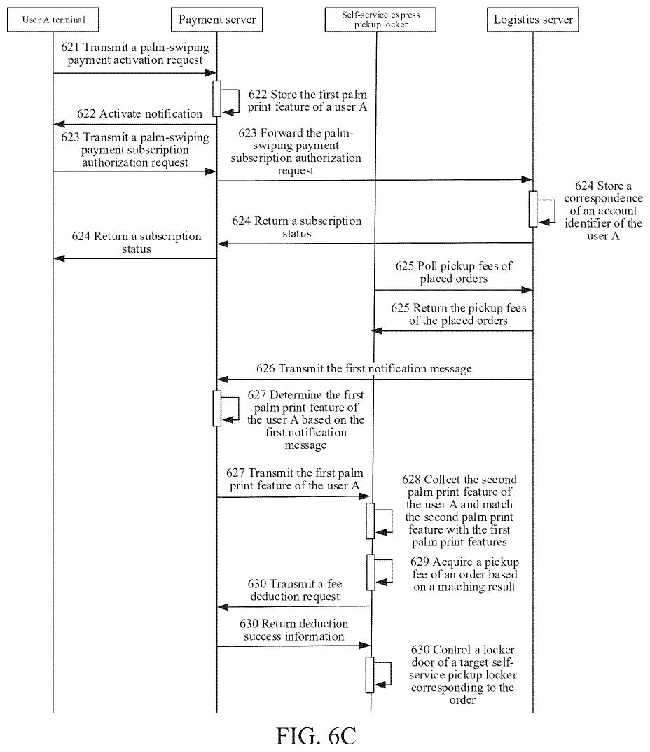

FIG. 6A is a schematic diagram of an electronic locker control system for an express scenario according to an embodiment of this application.

When the electronic locker control method provided in this embodiment of this application is used for pickup, the user is required to pre-activate a palm-swiping payment function and grant subscription authorization for palm-swiping payment.

The user A may activate palm-swiping payment by using a payment application (an application having a payment function, a payment application corresponding to the payment server) installed on the terminal 604. In response to an operation of activating palm-swiping payment of the user A, the terminal 604 invokes a camera in the terminal 604 to collect streaming media data of a palm of the user A, where the streaming media data includes a plurality of palm print images. The terminal 604 may determine an image with the highest quality in the plurality of collected palm print images according to evaluation indexes such as a palm size, a palm angle, image contrast, brightness, and definition in the palm print images, and transmits a palm-swiping payment activation request carried with the palm print image with the highest quality to the payment server 601. The payment server 601 may extract the first palm print feature of the user A according to the palm print image in the palm-swiping payment activation request, and associatively store the first palm print feature and a payment account identifier of the user A into the third mapping relationship.

When storing the first palm print feature of the user A, the payment server 601 may match the first palm print feature of the user A with first palm print features of users already stored in the database. When no matching first palm print feature exists in the database, storage is performed again, to avoid repeated storage of the first palm print feature of the user A.

The user A may perform a palm-swiping payment subscription authorization operation on the payment application of the terminal 604. After the user A performs the authorization operation, the terminal 604 transmits a palm-swiping payment subscription authorization request to the payment server 601, and the payment server 601 forwards the palm-swiping payment subscription authorization request to the logistics server 602. The logistics server 602 stores the payment account identifier and an express account identifier of the user into the second mapping relationship according to the payment account identifier and the express account identifier of the user A in the palm-swiping payment subscription authorization request.

After a courier places an express order item of the user A to a self-service express pickup locker 603, the courier may transmit order status information of an express order of the user A to the logistics server 602 through the terminal or the self-service express pickup locker 603. The logistics server 602 may forward the order status information of the express order of the user A to the terminal 604 of the user A through the payment server 601, to prompt the user A to head for pickup. The order status information includes an order placement completion time, the express account identifier of the user A, and a self-service pickup locker identifier of the self-service express pickup locker 603 of the order placement.

After receiving the order status information of the express order of the user A, the logistics server 602 may determine that the order placement is completed, determine the payment account identifier of the user A according to a stored correspondence (second mapping relationship) between express account identifiers and payment account identifiers of users, generate the first notification message according to the payment account identifier of the user A, an express merchant identifier, and the self-service pickup locker identifier of the self-service express pickup locker 603 of the order placement, and transmit the first notification message to the payment server 601. The payment account identifier of the user may be an identity identifier OpenID of the user corresponding to the payment application, and the express merchant identifier may be a payment merchant number MCH-ID of a merchant, and the self-service pickup locker identifier of the self-service express pickup locker 603 may also be a device identifier SN of a palm-swiping device in the self-service express pickup locker 603.

Because a pickup fee of an express is positively correlated to a storage duration of the express, the self-service express pickup locker 603 may poll the logistics server 602 for a pickup fee of each placed order, and receive the pickup fee of each order returned by the logistics server 602, and update and store the first mapping relationship. The first mapping relationship includes a correspondence between express account identifiers corresponding to the orders that are already placed into the self-service express pickup locker 603 and the pickup fees.

The payment server 601 determines the first palm print feature of the user A from the stored first palm print features of the users according to the received first notification message and based on a correspondence (the third mapping relationship) between payment account identifiers and the first palm print features of the users, and transmits the first palm print feature of the user A to the self-service express pickup locker 603.

Before distributing the first palm print feature of a target user to the self-service express pickup locker 603, the payment server 601 may first query, based on the payment account identifier of the user A, whether the first palm print feature of the user A exists in a biometric feature database of the self-service express pickup locker 603. If yes, the first palm print feature of the payment server 601 is further compared with the first palm print feature of the self-service express pickup locker 603, and incremental data of the palm print feature is distributed. If not, the first palm print feature of the user A is directly distributed.

The self-service express pickup locker 603 associatively stores the received first palm print feature of the user A and the express account identifier of the user A into a local palm print feature database.

When the user A arrives at the self-service express pickup locker 603 for pickup, the user A may tap “I want to pick up a parcel” on a display screen of the self-service pickup locker, and collect the second palm print feature through a 3D camera configured on the self-service express pickup locker 603. The 3D camera may be disposed below the display screen of the self-service pickup locker, and the user A covers the palm right above the 3D camera, to complete collection of the palm print feature.

In some embodiments, the 3D camera may collect a plurality of palm print images of the user A, and determine a palm print image with the highest quality based on evaluation indexes such as a palm size, a palm angle, image contrast, brightness, and definition in the palm print images, and extract the second palm print feature of the user A based on the palm print image with the highest quality.

The self-service express pickup locker 603 may match the collected second palm print feature with each locally-stored first palm print feature in the palm print feature database, and if the first palm print feature matching the second palm print feature exists in the palm print feature database, a pickup fee of an order of the user A is determined according to an express account identifier associated with the matching first biometric feature and a pickup fee of each order obtained by polling.

During feature matching, to improve feature matching accuracy, a dimensionality reduction algorithm may be used to match the collected second palm print feature with each first palm print feature. The dimensionality reduction algorithm means that irrelevant or redundant features are removed, and remaining core features are compared to determine whether a match exists.

The self-service express pickup locker 603 may transmit a fee deduction request to the payment server 601 based on the pickup fee of the order of the user A, and receive deduction success information returned by the payment server 601.

After the deduction succeeds, the self-service express pickup locker 603 may determine a target self-service pickup locker corresponding to the order of the user A in the self-service express pickup locker 603, and control a locker door of the target self-service pickup locker to be opened, allowing the user A for pickup.

In some embodiments, considering that the self-service express pickup locker 603 is usually placed at a corner location of a residential community or an office building, and a network signal is poor, the self-service express pickup locker 603 may detect a current network status after the feature matching succeeds, that is, after the identity authentication succeeds. When the network status is poor, the locker door of the target self-service pickup locker corresponding to the order of the user A is directly controlled to be opened, and the payment server 601 is requested to perform asynchronous deduction when the network status is good.

If the locker door of the target self-service pickup locker is not opened, the user A may still assist in pickup in modes such as inputting a pickup code on the display screen of the self-service pickup locker.

FIG. 6B is a schematic structural diagram of an electronic locker control system for an express scenario according to an embodiment of this application.

A payment server 611 includes a database and four service modules: a palm-swiping payment activation service, a palm-swiping payment subscription authorization service, a palm-swiping payment library push service, and an asynchronous deduction payment service. The palm-swiping payment activation service is configured for processing a palm-swiping payment activation request. The palm-swiping payment subscription authorization service is configured for processing a palm-swiping payment subscription authorization request. The palm-swiping payment library push service is configured for distributing first palm print features to an electronic locker 613. The asynchronous deduction payment service is configured for executing fee deduction, receiving a fee deduction request transmitted by the electronic locker 613, and performing a fee deduction operation based on a pickup fee. The database is configured to store the third mapping relationship, namely a correspondence between payment account identifiers of a plurality of users and the first palm print features.

A payment application is installed in a terminal 614. The payment application has a palm-swiping payment activation module and an express merchant authorization module. The palm-swiping payment activation module further includes a preferred selection submodule and a liveness detection submodule. The express merchant authorization module includes a palm-swiping binding submodule. The liveness detection submodule is configured to perform liveness detection on the user. The preferred selection submodule is configured to select a palm print image with the highest quality from a plurality of collected palm print images. The palm-swiping binding submodule is configured to perform a palm-swiping payment subscription authorization operation by the user. The palm-swiping payment activation module is configured to perform a palm-swiping payment activation operation by the user.

A logistics server 612 includes a database, a palm-swiping payment subscription authorization service module, and a library distribution notification module. The palm-swiping payment subscription authorization service module is configured to receive the palm-swiping payment subscription authorization request forwarded by the payment server 611, and return subscription status information. The library distribution notification module is configured to transmit the first notification message to the palm-swiping payment library push service in the payment server 611 after it is determined that an order is already placed into the electronic locker 613, such that the payment server 611 transmits the first palm print feature to the electronic locker 613. The database is configured to store the second mapping relationship, namely a correspondence between payment account identifiers of a plurality of users and express account identifiers.

A palm-swiping application and an express merchant application are installed in the electronic locker 613. The palm-swiping application includes a palm-swiping recognition module and a library retrieval module. The express merchant application includes an order update module. The palm-swiping recognition module is configured to collect a palm print image of the user and extract the second palm print feature of the user. The library retrieval module is configured to receive and store the first palm print feature of the user transmitted by the payment server 611, and match the second palm print feature with each stored first palm print feature.

FIG. 6C is a flowchart of an interaction between devices in an express pickup scenario according to an embodiment of this application. The following is a description of an interaction process between the devices in a pickup process in combination with a specific application scenario in which the user A picks up an express item, and the following operations are specifically included:
621: A terminal of a user A transmits a palm-swiping payment activation request to a payment server in response to a palm-swiping payment activation operation of the user A.

The palm-swiping activation request carries a palm print image of the user A.
622: The payment server stores the first palm print feature of the user A according to a received palm-swiping activation request, and returns activation success information to the terminal.

The payment server may extract and store the first palm print feature of the user A according to the palm print image in the palm-swiping payment activation request.
623: The terminal transmits a palm-swiping payment subscription authorization request to the payment server in response to a palm-swiping payment subscription authorization operation of the user A, and the payment server forwards the palm-swiping payment subscription authorization request to a logistics server.
624: The logistics server stores a correspondence between a payment account identifier and express account identifiers of the user A based on the palm-swiping payment subscription authorization request, and returns a subscription status to the terminal via the payment server.

The logistics server stores the payment account identifier and the express account identifiers of the user into the second mapping relationship according to the payment account identifier and the express account identifiers of the user in a palm-swiping binding request.
625: A self-service express pickup locker polls the logistics server for a pickup fee of each order that is already placed into the self-service express pickup locker, and receives the pickup fee of each placed order returned by the logistics server.
626: The logistics server transmits the first notification message to the payment server after acquiring that an order of the user is already placed into the self-service express pickup locker.
627: The payment server transmits the first palm print feature of the user A to the self-service express pickup locker in response to the first notification message.
628: The self-service express pickup locker invokes, in response to a pickup operation of the user A, a 3D camera to collect the second palm print feature of the user A, and matches a collected second palm print feature with received first palm print features.
629: The self-service express pickup locker, if the first palm print feature matching the second palm print feature exists, acquires a pickup fee of an express order of the user A based on an express account identifier associated with a matching first palm print feature.
630: The self-service express pickup locker transmits a fee deduction request to the payment server based on the pickup fee, receives deduction success information returned by the payment server, and controls a locker door of a target self-service pickup locker corresponding to the express order of the user A to be opened.

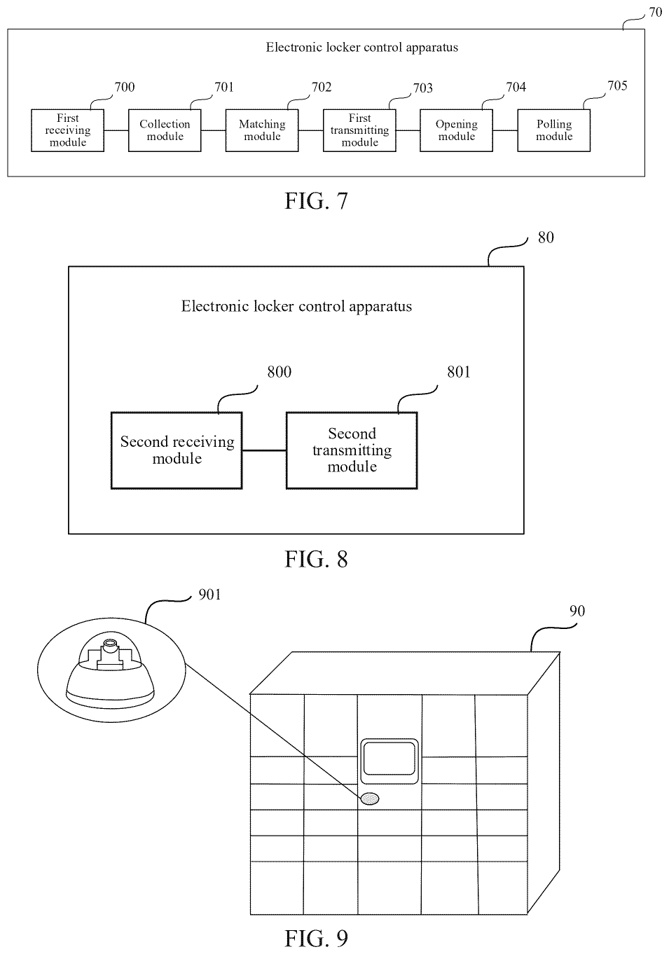

Based on the electronic locker control method shown in FIG. 1, an embodiment of this application further provides an electronic locker control apparatus. As shown in FIG. 7, the electronic locker control apparatus 70 may include:
a receiving module 700, configured to: receive the first biometric feature of the first target object transmitted by the first server, and store the first biometric feature of the first target object into a biometric feature database, where the first server has first biometric features of a plurality of objects stored therein; the second server transmits the first notification message to the first server when determining that the first target order of the first target object is already placed into the electronic locker; and the first server transmits the first biometric feature of the first target object when receiving the first notification message;
a collection module 701, configured to: invoke a biometric feature collection device to collect the second biometric feature of the first target object in response to a pickup operation of the first target object for the electronic locker;
a matching module 702, configured to: separately match the second biometric feature of the first target object with first biometric features in the biometric feature database;
the first transmitting module 703, configured to: perform identity authentication on the first target object and transmit a pickup payment request to the first server when the first biometric feature matching the second biometric feature exists in the biometric feature database;
the first receiving module 700, further configured to receive a payment success response returned by the first server; and
an opening module 704, configured to: transmit, in response to the payment success response to, the first opening instruction to a target electronic storage compartment corresponding to the first target order in the electronic locker, to control a locker door of the target electronic storage compartment to be opened.

In some embodiments, the electronic locker further includes a polling module 705, and the polling module 705 may be configured to poll the second server for a pickup cost of each order already placed into the electronic locker.

The first receiving module 700 is further configured to receive the pickup cost of each order returned by the second server, and update the first mapping relationship between the pickup costs of the orders and first object identifiers used when the orders are stored in the electronic locker; and associatively store the first biometric feature and the first object identifiers into the biometric feature database.

The first transmitting module 703 is configured to determine, in the biometric feature database, the first object identifier associated with the first biometric feature matching the second biometric feature; and obtain, by querying based on the first mapping relationship, a pickup cost corresponding to the determined first object identifier, and carry the pickup cost in the pickup payment request.

In some embodiments, the second server has the first object identifier of the first target object stored therein, and the first object identifier is configured for storing orders in the electronic locker.

The first notification message is generated by the second server through the following mode:
determining, based on the first object identifier of the first target object and a stored second mapping relationship, the second object identifier of the first target object stored in the first server when determining that the first target order is placed into the electronic locker, the second mapping relationship including a correspondence between the first object identifiers and second object identifiers of the plurality of objects; and
generating the first notification message, the first notification message including the second object identifier of the first target object and a locker identifier of the electronic locker.

The first biometric feature of the first target object is transmitted by the first server through the following mode:
determining the first biometric feature of the first target object in stored first biometric features of the objects according to the second object identifier in the first notification message and a stored third mapping relationship, where the third mapping relationship includes a correspondence between the second object identifiers and the first biometric features of the plurality of objects; and
transmitting the first biometric feature of the first target object to the electronic locker according to the locker identifier in the first notification message.

In some embodiments, the first server obtains the third mapping relationship through the following mode:
receiving a payment authorization activation request transmitted by a user terminal of the first target object, where
the payment authorization activation request includes the second object identifier and a biometric feature image of the first target object; and
the biometric feature image is collected by an image collection device of the user terminal when the user terminal receives a payment authorization activation operation triggered by the first target object;
extracting the first biometric feature of the first target object from the biometric feature image; and
associatively storing the second object identifier and an extracted first biometric feature in the payment authorization activation request into the third mapping relationship.

In some embodiments, the second server obtains the second mapping relationship through the following mode:
receiving a payment authorization binding request transmitted by the user terminal of the first target object,
the authorization binding request being transmitted by the user terminal when receiving a payment authorization binding operation triggered by the first target object; and
the payment authorization binding request including the first object identifier and the second object identifier of the first target object; and
associatively storing the first object identifier and the second object identifier of the first target object into the second mapping relationship based on the payment authorization binding request.

In some embodiments, the first receiving module 700 is further configured to: receive the first biometric feature of the second target object transmitted by the first server, and store the first biometric feature of the second target object into the biometric feature database, where
the second server transmits the second notification message to the first server when receiving a parcel sending request of the second target order of the second target object; and
the first server transmits the first biometric feature of the second target object when receiving the second notification message.

The matching module 702 is further configured to invoke, in response to a parcel sending operation of the second target object, the biometric feature collection device to collect the second biometric feature of the second target object, and separately match the second biometric feature of the second target object with the first biometric features in the biometric feature database.

The first transmitting module 703 is further configured to perform identity authentication on the second target object and transmit a parcel sending payment request to the first server when the first biometric feature matching the second biometric feature of the second target object exists in the biometric feature database.

The opening module 704 is further configured to transmit the second opening instruction to an available electronic storage compartment in the electronic locker to control a locker door of the available electronic storage compartment to be opened when receiving a parcel sending payment success response returned by the first server.

In some embodiments, the opening module 703 is further configured to delete the first biometric feature of the first target object from the biometric feature database in response to the locker door of the target electronic storage compartment being closed.

In some embodiments, the first biometric feature and the second biometric feature are palm print features.

Based on the electronic locker control method shown in FIG. 3, an embodiment of this application further provides a schematic diagram of an electronic locker control apparatus. As shown in FIG. 8, the electronic locker control apparatus 80 may include:
the second receiving module 800, configured to: receive the first notification message transmitted by the second server, where the second server transmits the first notification message when determining that the first target order of the first target object is already placed into an electronic locker; and
the second transmitting module 801, configured to: transmit, in response to a target electronic locker indicated by the first notification message, the first biometric feature of the first target object to the first electronic device connected to the target electronic locker, such that the first electronic device performs the following operation: storing the first biometric feature of the first target object into a biometric feature database; invoking a biometric feature collection device to collect the second biometric feature of the first target object in response to a pickup operation of the first target object for the target electronic locker; and performing identity authentication on the first target object and transmitting a pickup payment request when the first biometric feature matching the second biometric feature exists in the biometric feature database.

The second receiving module 800 is further configured to receive the pickup payment request from the first electronic device, and deduct a pickup cost of the first target order.

The second transmitting module 801 is further configured to return a payment success response to the first electronic device, such that the first electronic device transmits, in response to the payment success response, the first opening instruction to a target electronic storage compartment corresponding to the first target order in the target electronic locker, to control a locker door of the target electronic storage compartment to be opened.

An embodiment of this application further provides a non-transitory computer-readable storage medium having a computer program stored therein, and the computer program, when executed by a processor, implements the method provided in any exemplary embodiment of this application.

Based on the electronic locker control method shown in FIG. 1, an embodiment of this application further provides an electronic locker. According to a schematic structure of an electronic locker shown in FIG. 9, the electronic locker 90 includes at least one electronic storage compartment, at least one biometric feature collection device 901, a processor (including the electronic locker control apparatus described in this embodiment of this application), an internal bus, a network interface, an internal memory, and a non-volatile memory. The biometric feature collection device 901 may be a palm print feature collection device, a fingerprint collector, a camera, etc. An electronic lock is correspondingly disposed on each electronic storage compartment. The processor may control on/off of the electronic lock and control the biometric feature collection device 901 for feature collection. The electronic locker may further include hardware required by other services. The processor reads a corresponding computer program from the non-volatile memory into the internal memory and then runs the computer program to implement the method provided in any exemplary embodiment of this application.

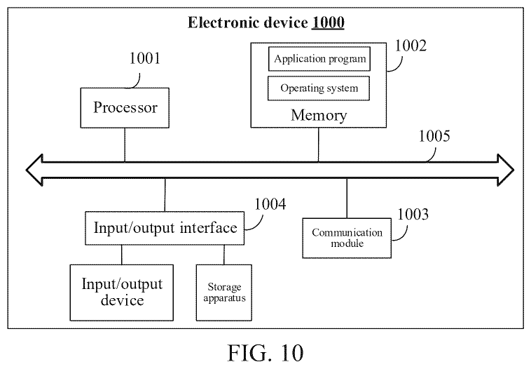

An embodiment of this application further provides an electronic device. As shown in FIG. 10, the electronic device includes at least one processor, and the processor is configured to perform the operations of the method provided in any exemplary embodiment of this application. In some embodiments, the electronic device may further include a transceiver and/or a memory coupled to the processor. The memory has a computer program stored therein. The processor, when running the computer program, may implement a solution provided in any exemplary embodiment of this application. In some embodiments, the electronic device may be an electronic locker control apparatus or a payment server.

In addition to a software implementation, the embodiments of this specification do not exclude other implementations, for example, logic devices or a software-hardware combination. That is, executing entities of the following processing procedures are not limited to logic units and may alternatively be hardware or logic devices.

FIG. 10 shows a schematic structural diagram of an electronic device applicable to embodiments of this application. As shown in FIG. 10, the electronic device may be the first electronic device, corresponding to an electronic locker control apparatus, or the second electronic device corresponding to a payment server, for implementing the method provided in the foregoing embodiments of this application.

As shown in FIG. 10, an electronic device 1000 may mainly include components such as at least one processor 1001 (one is shown in FIG. 10), a memory 1002, a communication module 1003, and an input/output interface 1004. In some embodiments, the components may be in connection communication through a bus 1005. The structure of the electronic device 1000 shown in FIG. 10 is merely exemplary, and does not constitute a limitation to the electronic device applicable to the method provided in the embodiments of this application.

The memory 1002 may be configured to store an operating system, an application program, and the like. The application program may include a computer program implementing the method provided in the embodiments of this application when being invoked by the processor 1001, and may further include a program configured for implementing other functions or services. The memory 1002 may be a read only memory (ROM) or another type of static storage device capable of storing static information and instructions, a random access memory (RAM) or another type of dynamic storage device capable of storing information and computer programs, or may be an electrically erasable programmable read only memory (EEPROM), a compact disc read only memory (CD-ROM) or another optical disk memory, an optical disk memory (including a compact disc, a laser disk, an optical disk, a digital universal disk, a blue-ray disc, and the like), a magnetic disk storage medium or another magnetic storage device, or any other medium capable of being configured for carrying or storing expected program codes in an instruction or a data structure form and capable of being accessed by a computer, but it is not limited thereto.

The processor 1001 is connected to the memory 1002 through the bus 1005, and implements corresponding functions by invoking the application program stored in the memory 1002. The processor 1001 may be a central processing unit (CPU), a general purpose processor, a digital signal processor (DSP), an application specific integrated circuit (ASIC), a field programmable gate array (FPGA), or another programmable logic device, a transistor logic device, a hardware component, or a free combination thereof, and it may implement or perform various exemplary logic blocks, modules, and circuits described in combination with the disclosed contents of this application. The processor 1001 may also be a combination that implements a computing function, such as a combination of one or more microprocessors, or a combination of a DSP and a microprocessor.

The electronic device 1000 may be connected to a network through the communication module 1003 (which may include but not limited to components such as a network interface) to communicate with other devices (e.g., a user terminal or a server) through the network for implementing data exchange, such as data transmission to other devices or data receiving from other devices. The communication module 1003 may include a wired network interface, and/or a wireless network interface, and the like. That is, the communication module may include at least one of a wired communication module or a wireless communication module.

The electronic device 1000 may be connected to a required input/output device such as a keyboard or a display device through the input/output interface 1004. The electronic device 1000 may have a display device, or may be externally connected to another display device through the interface 1004. In some embodiments, a storage apparatus such as a hard disk may further be connected through the interface 1004, such that data in the electronic device 1000 may be stored into the storage apparatus, or data in the storage apparatus may be read, and data in the storage apparatus may further be stored into the memory 1002. The input/output interface 1004 may be a wired interface, or may be a wireless interface. According to different actual application scenarios, a device connected to the input/output interface 1004 may be a component of the electronic device 1000, or may be an external device connected to the electronic device 1000 when required.

The bus 1005 configured to connect the components may include a channel to transmit information among the components. The bus 1005 may be a peripheral component interconnect (PCI) bus, an extended industry standard architecture (EISA) bus, or the like. According to different functions, the bus 1005 may be classified into an address bus, a data bus, a control bus, and the like.

In some embodiments, for the solutions provided by the embodiments of this application, the memory 1002 may be configured to store a computer program implementing the solutions of this application and operated by the processor 1001. The processor 1001, when running the computer program, implements actions of the method or the apparatus provided in the embodiments of this application.

Based on the principle the same as the method provided in the embodiments of this application, an embodiment of this application provides a non-transitory computer-readable storage medium. The computer-readable storage medium has a computer program stored therein, and the computer program, when executed by a processor, may implement the corresponding contents of the foregoing method embodiments.

An embodiment of this application further provides a computer program product, and the product includes a computer program. The computer program, when executed by a processor, may implement the corresponding contents of the foregoing method embodiments.

The terms such as “first”, “second”, “third”, “fourth”, “1”, and “2” (if any) in the description, the claims, and the foregoing accompanying drawings of this application are used to distinguish similar objects and not necessarily used to describe a specific order or sequence. Such used data is interchangeable where appropriate, and the embodiments of this application described here may be implemented in an order other than that illustrated or described in the accompanying drawings or text.

Although the steps are indicated according to the arrows in the flowcharts of the embodiments of this application, an implementation sequence of these steps is not necessarily limited by the sequence instructed by the arrows. Unless otherwise explicitly specified, in some implementation scenarios of the embodiments of this application, the implementation steps in each flowchart may be performed in another sequence according to requirements. In addition, some or all of the steps in each flowchart may include a plurality of sub-steps or a plurality of stages based on an actual implementation scenario. Some or all of these sub-steps or stages may be performed at the same moment, and each of these sub-steps or stages may be separately performed at a different moment. In a scenario with different implementation moments, an implementation sequence of these sub-steps or stages may be flexibly configured as needed, which is not limited in the embodiments of this application.

In the embodiments of this application, the term “module” refers to a computer program with a preset function or a part of the computer program and works, together with other related parts, to implement a preset target, which may be completely or partially implemented by using software, hardware (such as a processing circuit or a memory) or a combination thereof. Similarly, one processor (or a plurality of processors or memories) may be configured to implement one or more modules. In addition, each module may be a part of an overall module including a function of the module. The above contents are some exemplary implementations of the implementation scenario of this application. Those of ordinary skill in the art may adopt other similar implementation means based on the technical idea of this application without departing from the technical concept of the solutions of this application, and these similar implementation means still fall within the scope of protection of the embodiments of this application.

What is claimed is:

1. A method for controlling an electronic locker performed by a first electronic device, the electronic locker being configured with a biometric feature collection device and a plurality of electronic storage compartments, and the method comprising:
invoking the biometric feature collection device to collect a second biometric feature of a first target object in response to a pickup operation of the first target object for accessing the electronic locker;
matching the second biometric feature of the first target object with first biometric features stored in a biometric feature database;
transmitting a payment request to a first server when one of the first biometric features matching the second biometric feature exists in the biometric feature database; and
opening a target electronic storage compartment in the electronic locker according to a first target order associated with the first target object after receiving a payment success response returned by the first server.

2. The method according to claim 1, further comprising:
polling a second server for a pickup cost of each order already placed into the electronic locker;
receiving the pickup cost of each order returned by the second server, and updating the first mapping relationship between pickup costs of orders and first object identifiers used when the orders are stored in the electronic locker;
associatively storing one of the first biometric features and a first object identifier into the biometric feature database; and
determining, in the biometric feature database, the first object identifier associated with the first biometric feature matching the second biometric feature; and
obtaining, by querying based on the first mapping relationship, a pickup cost corresponding to a determined first object identifier, and carrying the pickup cost in the pickup payment request.

3. The method according to claim 1, wherein the method further comprises:
receiving a first biometric feature of the first target object transmitted by the first server, and storing the first biometric feature of the first target object into the biometric feature database, the first server having first biometric features of a plurality of objects stored therein;
transmitting a first notification message to the first server when determining that the first target order associated with the first target object is already placed into the electronic locker.

4. The method according to claim 3, wherein the second server has the first object identifier of the first target object stored therein, and the first object identifier is configured for storing the orders in the electronic locker;
the first notification message is generated by the second server through the following mode:
determining, based on the first object identifier of the first target object and a stored second mapping relationship, the second object identifier of the first target object stored in the first server when determining that the first target order is placed into the electronic locker, the second mapping relationship comprising a correspondence between the first object identifiers and second object identifiers of the plurality of objects; and
generating the first notification message, the first notification message comprising the second object identifier of the first target object and a locker identifier of the electronic locker; and
the first biometric feature of the first target object is transmitted by the first server through the following mode:
determining the first biometric feature of the first target object in stored first biometric features of the objects according to the second object identifier in the first notification message and a stored third mapping relationship, the third mapping relationship comprising a correspondence between the second object identifiers and the first biometric features of the plurality of objects; and
transmitting the first biometric feature of the first target object to the electronic locker according to the locker identifier in the first notification message.

5. The method according to claim 3, wherein the first server obtains the third mapping relationship through the following mode:
receiving a payment authorization activation request transmitted by a user terminal of the first target object,
the payment authorization activation request comprising the second object identifier and a biometric feature image of the first target object; and
the biometric feature image being collected by an image collection device of the user terminal when the user terminal receives a payment authorization activation operation triggered by the first target object;
extracting the first biometric feature of the first target object from the biometric feature image; and
associatively storing the second object identifier and an extracted first biometric feature in the payment authorization activation request into the third mapping relationship.

6. The method according to claim 3, wherein the second server obtains the second mapping relationship through the following mode:
receiving a payment authorization binding request transmitted by the user terminal of the first target object,
the authorization binding request being transmitted by the user terminal when receiving a payment authorization binding operation triggered by the first target object; and
the payment authorization binding request comprising the first object identifier and the second object identifier of the first target object; and
associatively storing the first object identifier and the second object identifier of the first target object into the second mapping relationship based on the payment authorization binding request.

7. The method according to claim 1, further comprising:
receiving the first biometric feature of the second target object transmitted by the first server, and storing the first biometric feature of the second target object into the biometric feature database,
the second server transmitting the second notification message to the first server when receiving a parcel sending request of the second target order of the second target object; and
the first server transmitting the first biometric feature of the second target object when receiving the second notification message;
invoking the biometric feature collection device to collect the second biometric feature of the second target object in response to a parcel sending operation of the second target object, and separately matching the second biometric feature of the second target object with the first biometric features in the biometric feature database;
performing identity authentication on the second target object and transmitting a parcel sending payment request to the first server when the first biometric feature matching the second biometric feature of the second target object exists in the biometric feature database; and
transmitting the second opening instruction to an available electronic storage compartment in the electronic locker to control a locker door of the available electronic storage compartment to be opened when receiving a parcel sending payment success response returned by the first server.

8. The method according to claim 1, further comprising:
deleting the first biometric feature of the first target object from the biometric feature database in response to the locker door of the target electronic storage compartment being closed.

9. The method according to claim 1, wherein the first biometric feature and the second biometric feature are both palm print features.

10. A first electronic device for controlling an electronic locker, the electronic locker being configured with a biometric feature collection device and a plurality of electronic storage compartments, the first electronic device comprising a memory, a processor, and a computer program stored in the memory, and the processor, when executing the program, causing the first electronic device to implement a method for controlling the electronic locker, the method comprising:
invoking the biometric feature collection device to collect a second biometric feature of a first target object in response to a pickup operation of the first target object for accessing the electronic locker;
matching the second biometric feature of the first target object with first biometric features stored in a biometric feature database;
transmitting a payment request to a first server when one of the first biometric features matching the second biometric feature exists in the biometric feature database; and
opening a target electronic storage compartment in the electronic locker according to a first target order associated with the first target object after receiving a payment success response returned by the first server.

11. The first electronic device according to claim 10, wherein the method further comprises:
polling a second server for a pickup cost of each order already placed into the electronic locker;
receiving the pickup cost of each order returned by the second server, and updating the first mapping relationship between pickup costs of orders and first object identifiers used when the orders are stored in the electronic locker;
associatively storing one of the first biometric features and a first object identifier into the biometric feature database; and
determining, in the biometric feature database, the first object identifier associated with the first biometric feature matching the second biometric feature; and
obtaining, by querying based on the first mapping relationship, a pickup cost corresponding to a determined first object identifier, and carrying the pickup cost in the pickup payment request.

12. The first electronic device according to claim 10, wherein the method further comprises:
receiving a first biometric feature of the first target object transmitted by the first server, and storing the first biometric feature of the first target object into the biometric feature database, the first server having first biometric features of a plurality of objects stored therein;
transmitting a first notification message to the first server when determining that the first target order associated with the first target object is already placed into the electronic locker.

13. The first electronic device according to claim 12, wherein the second server has the first object identifier of the first target object stored therein, and the first object identifier is configured for storing the orders in the electronic locker;
the first notification message is generated by the second server through the following mode:
determining, based on the first object identifier of the first target object and a stored second mapping relationship, the second object identifier of the first target object stored in the first server when determining that the first target order is placed into the electronic locker, the second mapping relationship comprising a correspondence between the first object identifiers and second object identifiers of the plurality of objects; and
generating the first notification message, the first notification message comprising the second object identifier of the first target object and a locker identifier of the electronic locker; and
the first biometric feature of the first target object is transmitted by the first server through the following mode:
determining the first biometric feature of the first target object in stored first biometric features of the objects according to the second object identifier in the first notification message and a stored third mapping relationship, the third mapping relationship comprising a correspondence between the second object identifiers and the first biometric features of the plurality of objects; and
transmitting the first biometric feature of the first target object to the electronic locker according to the locker identifier in the first notification message.

14. The first electronic device according to claim 12, wherein the first server obtains the third mapping relationship through the following mode:
receiving a payment authorization activation request transmitted by a user terminal of the first target object,
the payment authorization activation request comprising the second object identifier and a biometric feature image of the first target object; and
the biometric feature image being collected by an image collection device of the user terminal when the user terminal receives a payment authorization activation operation triggered by the first target object;
extracting the first biometric feature of the first target object from the biometric feature image; and
associatively storing the second object identifier and an extracted first biometric feature in the payment authorization activation request into the third mapping relationship.

15. The first electronic device according to claim 12, wherein the second server obtains the second mapping relationship through the following mode:
receiving a payment authorization binding request transmitted by the user terminal of the first target object,
the authorization binding request being transmitted by the user terminal when receiving a payment authorization binding operation triggered by the first target object; and
the payment authorization binding request comprising the first object identifier and the second object identifier of the first target object; and
associatively storing the first object identifier and the second object identifier of the first target object into the second mapping relationship based on the payment authorization binding request.

16. The first electronic device according to claim 10, wherein the method further comprises:
receiving the first biometric feature of the second target object transmitted by the first server, and storing the first biometric feature of the second target object into the biometric feature database,
the second server transmitting the second notification message to the first server when receiving a parcel sending request of the second target order of the second target object; and
the first server transmitting the first biometric feature of the second target object when receiving the second notification message;
invoking the biometric feature collection device to collect the second biometric feature of the second target object in response to a parcel sending operation of the second target object, and separately matching the second biometric feature of the second target object with the first biometric features in the biometric feature database;
performing identity authentication on the second target object and transmitting a parcel sending payment request to the first server when the first biometric feature matching the second biometric feature of the second target object exists in the biometric feature database; and
transmitting the second opening instruction to an available electronic storage compartment in the electronic locker to control a locker door of the available electronic storage compartment to be opened when receiving a parcel sending payment success response returned by the first server.

17. The first electronic device according to claim 10, wherein the method further comprises:
deleting the first biometric feature of the first target object from the biometric feature database in response to the locker door of the target electronic storage compartment being closed.

18. The first electronic device according to claim 10, wherein the first biometric feature and the second biometric feature are both palm print features.

19. A non-transitory computer-readable storage medium, having a computer program stored therein, the computer program, when executed by a processor of a first electronic device for controlling an electronic locker, the electronic locker being configured with a biometric feature collection device and a plurality of electronic storage compartments, the first electronic device comprising a memory, a processor, and a computer program stored in the memory, and the processor, when executing the program, causing the first electronic device to implement a method for controlling the electronic locker, the method comprising:
invoking the biometric feature collection device to collect a second biometric feature of a first target object in response to a pickup operation of the first target object for accessing the electronic locker;
matching the second biometric feature of the first target object with first biometric features stored in a biometric feature database;
transmitting a payment request to a first server when one of the first biometric features matching the second biometric feature exists in the biometric feature database; and
opening a target electronic storage compartment in the electronic locker according to a first target order associated with the first target object after receiving a payment success response returned by the first server.

20. The non-transitory computer-readable storage medium according to claim 19, wherein the method further comprises:
polling a second server for a pickup cost of each order already placed into the electronic locker;
receiving the pickup cost of each order returned by the second server, and updating the first mapping relationship between pickup costs of orders and first object identifiers used when the orders are stored in the electronic locker;
associatively storing one of the first biometric features and a first object identifier into the biometric feature database; and
determining, in the biometric feature database, the first object identifier associated with the first biometric feature matching the second biometric feature; and
obtaining, by querying based on the first mapping relationship, a pickup cost corresponding to a determined first object identifier, and carrying the pickup cost in the pickup payment request.
